(19) United States
(12) Patent Application Publication
(10) Pub. No.: US 2006/0213823 A1
(43) Pub. Date: Sep. 28, 2006

(54) Accel-X™ HPLC column hardware

(76) Inventor: Michael Rigoli, (US)

Correspondence Address: LAMBERT & ASSOCIATES, P.L.L.C., 92 STATE STREET, BOSTON, MA, 02109-2004, US

(21) Appl. No.: 11/365,450

(22) Filed: Mar. 1, 2006

Related U.S. Application Data
(60) Provisional application No. 60/657,345, filed on Mar. 1, 2005.

(51) Int. Cl. B01D 15/08

(52) U.S. Cl. 210/198.2; 29/896.6; 73/61.53

(57) ABSTRACT

The present invention comprises the next generation of narrow bore HPLC Column Hardware. The inventors have developed and designed narrow bore column hardware that provides the ultimate configuration to obtain optimum peak shape, improved sensitivity and reduced backpressure. The improvements of the present invention comprise a new HPLC column hardware design that can be utilized to improve chromatographic performance as follows: reduced backpressure, reduced band broadening, and increased plate count.

### RELATED APPLICATIONS

The present invention claims the benefit of U.S. Provisional Application Ser. No. 60/657,345 entitled “Accel-X™ HPLC COLUMN HARDWARE” and filed Mar. 1, 2005, which is incorporated by reference herein in its entirety.

### BACKGROUND OF THE INVENTION

1. Field of the Invention

The present invention relates generally to the field of chromatographic columns and more particularly to narrow bore column hardware.

2. Description of the Related Art

The prior art in the field of chromatographic columns is numerous, and generally achieve the purposes for which they were intended. Examples of related prior art can be found in the following patents and published applications:

Picha, U.S. Pat. No. 5,540,464 discloses a capillary connector assembly for a capillary column. The assembly provides for a sealing means that does not require a sealing gasket. This accomplished by means of a slight deformation of one of the ends. The capillary column may be coated with a polymer layer to create the seal.

Tuvim, U.S. Pat. No. 6,527,951 discloses chromatographic filters that include a mesh screen. The mesh screen is coated with a polymer substance, such as Teflon®. The center of the screen is left without a coating to allow for transfer of the desired substance. Both sides of the screen are coated with the polymer, which in turn creates the seal within the column.

Picha, et al., U.S. Pat. No. 6,585,296 discloses a sealing system which is essentially the precursor for the patent granted to Picha noted above. The patent also discloses a central conduit that has an inner diameter in the range of 0.002 inch to about 0.125 inch.

Dourdeville, U.S. Pat. No. 6,610,201 discloses an HPLC delivery system for systems that utilize extremely narrow columns. Disclosed in the specification are columns that include inner diameters in the rane of 30 to 800 microns.

Huang et al., U.S. Publication No. 2005/0000900 discloses a so-called microfluidic chromatography system. The application discloses the need for extremely small columns, having inner diameters of 50 μm or less, and preferably of 10 μm or less. The system is also capable of operating with a flow rate of 0.01 μL/min or less.

Some of the problems and limitations of the prior art are discussed more fully below:

Reduced Dead volume—Dead volume occurs throughout the HPLC system and is defined as volume that the sample encounters in the flow path at the point of injecting the sample until the time it reaches the detector. Another definition is any volume which the sample encounters outside of the HPLC columns stationary phase/packing material. Dead volume can be a cause of sample dispersion which can contribute to band broadening.

Potential Dead Volume Contributors:

Tubing—Tubing is necessary to connect the primary components that the sample travels through in the flow path; injector, HPLC column, detector.

Connections/fittings—fittings are required to connect the tubing to the injector, HPLC column and detector.

Sample Injector—connections/fittings, sample loop, stator

HPLC column—connections/fittings, frit, void in stationary phase

Guard column—connections/fittings, frit, void in stationary phase

Detector—connections/fittings, flow cell

In-line filters—connections/fittings, filter element

By reducing dead volume you can have a positive impact on the performance of the HPLC system by improving peak shape. Reduced band broadening leads to improvements in peak height, resolution and accuracy of quantitation.

Backpressure—Backpressure is directly related to any device which causes resistance in the HPLC system flow path between the pump and the detector. In some cases there are devices placed post-detector. Backpressure is a limiting factor in that most of the devices in the flow path have a high pressure limit. When the high pressure limit is reached for any device, the backpressure must be reduced otherwise the system will be inoperable.

Potential Backpressure Contributors:

Tubing—small inner diameters cause resistance. Longer lengths have higher pressure

Connections/fittings—resistance in fitting connections

Sample Injector—tubing, small flow paths, connections/fittings cause resistance.

HPLC column—connections/fittings, frits but the stationary phase is the biggest contributor

Guard column—typically placed immediately before the HPLC column, (same as above)

Detector—connections/fittings, tubing, flow cell cause resistance.

In-line filters—placed anywhere between the pump and pre/post detector cause resistance

In most cases, the most significant contributor to backpressure is the HPLC column. Reduced backpressure allows for use of higher flow rates with longer column lifetimes.

### BRIEF SUMMARY OF THE INVENTION

The present invention is applicable to all column inner diameters ranging from 50μ to 100 mm.

A. Mesh/Screen Frit at Outlet With Thicker Frit (Sintered SS or Stack of Mesh) at Inlet, Standard Through Holes Both Ends, Frit Caps Both Ends

Mesh frits offer minimal dead volume.

Thicker frit helps to distribute sample across the entire diameter of the column bed/stationary phase. Even distribution of the sample increases capacity and reduces the potential for band broadening.

B. Mesh/Screen Frit at Outlet With Thicker Frit at Inlet Smaller (0.005″) Through Hole (or Through Hole to Match Capillary tubing ID 0.005, 0.007, 0.010, 0.020, 0.030, 0.040, 0.050″) at Outlet (and/or Inlet), Frit Caps Both Ends

Mesh frits offer minimal dead volume.

Thicker frit helps to disperse sample across the entire diameter of the column bed/stationary phase. Even distribution of the sample increases capacity and reduces the potential for band broadening.

The smaller through hole reduces dead volume and offers minimal dispersion as it matches the ID of the capillary tubing from the injector to the column inlet and from the column outlet to the detector

C. Mesh/Screen Frit at Outlet With Thicker Frit at Inlet, Smaller (0.005) Through Hole at Outlet (and/or Inlet), No Frit Cap at Outlet and/or Inlet.

Mesh frits offer minimal dead volume.

Thicker frit helps to disperse sample across the entire diameter of the column bed/stationary phase. Even distribution of the sample increases capacity and reduces the potential for band broadening.

The smaller through hole reduces dead volume and offers minimal dispersion as it matches the ID of the capillary tubing from the injector to the column inlet and from the column outlet to the detector

Eliminating the frit cap reduces dead volume in the through hole of the frit cap.

D. No Frit Cap (Capillary Tubing Face Seats Against Mesh/Screen) on Outlet and/or Inlet

Mesh frits offer minimal dead volume.

Thicker frit helps to disperse sample across the entire diameter of the column bed/stationary phase. Even distribution of the sample increases capacity and reduces the potential for band broadening.

The smaller through hole reduces dead volume and offers minimal dispersion as it matches the ID of the capillary tubing from the injector to the column inlet and from the column outlet to the detector

Eliminating the frit cap reduces dead volume in the through hole of the frit cap.

Reconfigured end fitting which allows for the capillary tubing to seat against the mesh reduces dead volume in the through hole.

E. No Frit Cap (Capillary Tubing Face Seats Against Mesh/Screen) on Outlet and/or Inlet With Pigtail on Outlet and/or Inlet

Mesh frits offer minimal dead volume.

Thicker frit helps to disperse sample across the entire diameter of the column bed/stationary phase. Even distribution of the sample increases capacity and reduces the potential for band broadening.

The smaller through hole reduces dead volume and offers minimal dispersion as it matches the ID of the capillary tubing from the injector to the column inlet and from the column outlet to the detector

Eliminating the frit cap reduces dead volume in the through hole of the frit cap.

Reconfigured end fitting which allows for the capillary tubing to seat against the mesh reduces dead volume in the through hole.

Reconfigured end fitting permanently attaches a pigtail of capillary tubing to provide the user with a column that does not require connecting fittings. The inlet pigtail connects the column to the injector or guard column or in-line filter. The outlet pigtail connects the column to the detector.

F. Matching Thru Hole of End Fitting and/or Frit Cap With id of Capillary Tubing

A) Matching the ID of the capillary tubing from the injector to the column inlet and from the column outlet to the detector reduces the potential for sample dispersion.

G. New Manufacturing Method Which Replaces the Outlet Frit Used in Packing with a Mesh Screen Frit.

The current method of manufacture leaves the outlet frit in place to be used with the finished product. The new manufacturing method replaces the outlet frit with a new frit/mesh which reduces backpressure.

H. Manufacturing Method Incorporates Outlet End Fitting During Packing Process Which is Easily Removed Without Disrupting Packing Material at Outlet

The current method of manufacture leaves the outlet frit in place to be used with the finished product. The new manufacturing method replaces the outlet frit with a new frit/mesh which reduces backpressure.

A column end fitting which allows for easy removal of the outlet frit is used during the packing process to prevent a disruption of the packing material at the outlet. Disruption of the packing material could cause a void in the column thereby increasing the risk of creating dead volume.

I. No Polymer Gasket Required to Seal (Smaller ID's)

A) A polymer gasket may introduce dead volume

polymer gasket holds screen in place in frit cap (larger ID's)

A) A gasket holds the screen in place making it easier for the user to pack the column without the screen becoming dislodged or mis-aligned. Misalignment could compromise the seal and cause a leak or introduce dead volume.

polymer coating on one side improves seal

Polymer coating of the mesh on one side improves the seal between the end of the column tube and the end fitting. Improving the seal reduces the potential for dead volume in the area between the end of the column tube and the mesh screen and the end fitting.

J. Ultrasonic Welding of the Mesh Frit to the End Fitting and/or Frit Cap

Welding of the mesh screen in place makes it easier for the user to pack the column without the screen becoming dislodged or mis-aligned. Misalignment could compromise the seal and cause a leak or introduce dead volume.

Welding of the mesh screen to the end fitting and/or frit cap improves the seal between the end of the column tube and the end fitting and frit cap. Improving the seal reduces the potential for dead volume in the area between the end of the column tube and the mesh screen and the end fitting.

Although the present invention has been described with reference to particular embodiments, it will be apparent to those skilled in the art that variations and modifications can be substituted therefore without departing from the principles and spirit of the invention.

### BRIEF DESCRIPTION OF THE SEVERAL VIEWS OF THE DRAWINGS

These and other features, aspects and advantages of the present invention will become better understood with reference to the following description, appended claims, and accompanying drawings where:

FIG. 1 illustrates the anatomy of a 50×2.1 mm Column, Conventional Design.

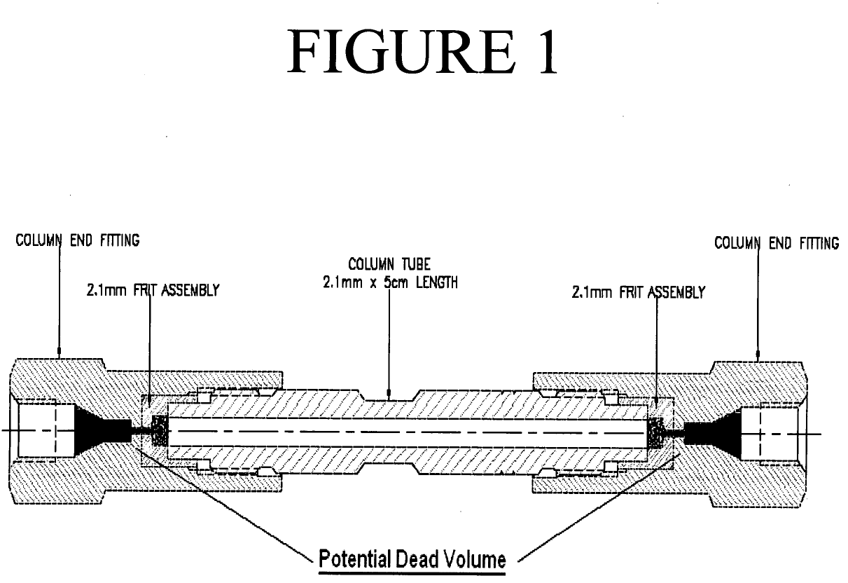

FIG. 2 illustrates the isocratic separation 50×2.1 mm, Conventional column hardware design.

FIG. 3 details standard column hardware.

FIG. 4 illustrates effect of frit thickness on plate count and peak symmetry.

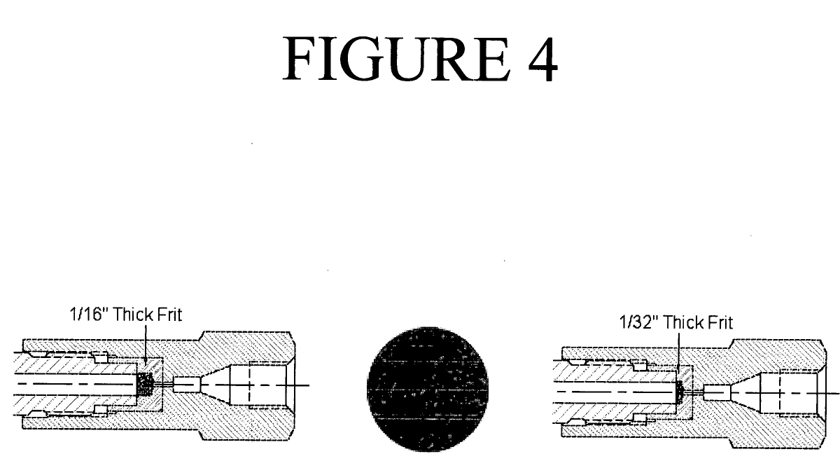

FIG. 5 details a 1/16″ frit vs. 1/32″ frit.

FIG. 6 shows the data for a 1/16″ frit vs. 1/32″ frit.

FIG. 7 is a standard end fitting compared to MDV end fitting.

FIG. 8 is a graphical representation of a standard vs. MDV fitting.

FIG. 9 is data for a standard vs MDV end fitting.

FIG. 10 is a graphical representation of overlaid chromatograms: standard vs. Accel-X.

FIG. 11 features the anatomy of a 50×2.1 mm HPLC Column, Accel-X design.

FIG. 12 depicts standard column hardware vs. Accel-X Column hardware.

FIG. 13 displays the data for standard vs. Accel-X.

FIG. 14. displays inlet and outlet details.

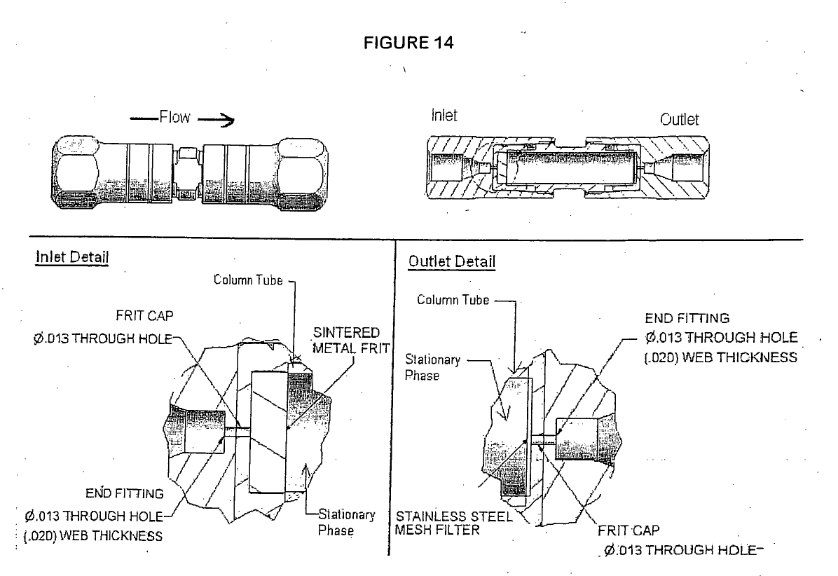

FIG. 15 displays inlet and outlet details.

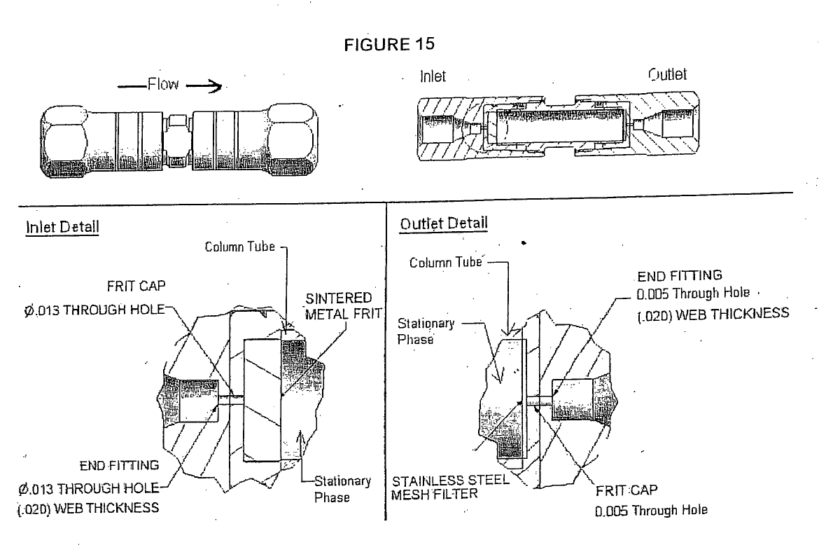

FIG. 16 displays inlet and outlet details.

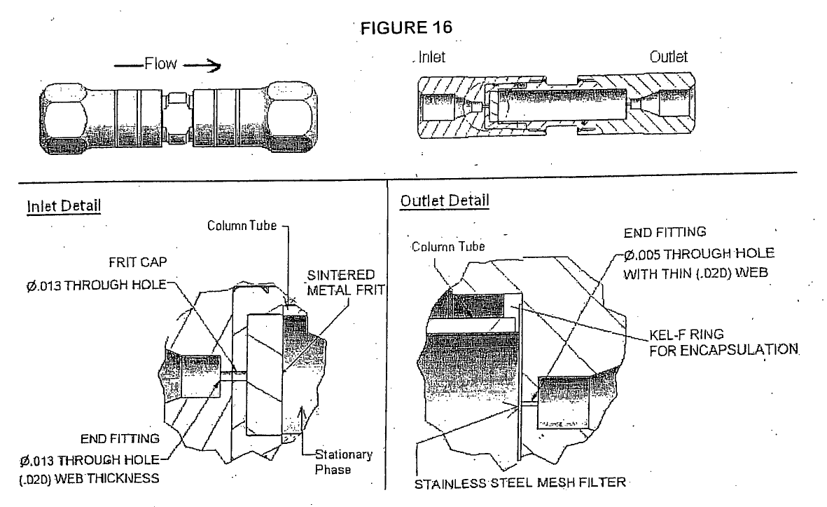

FIG. 17 displays inlet and outlet details.

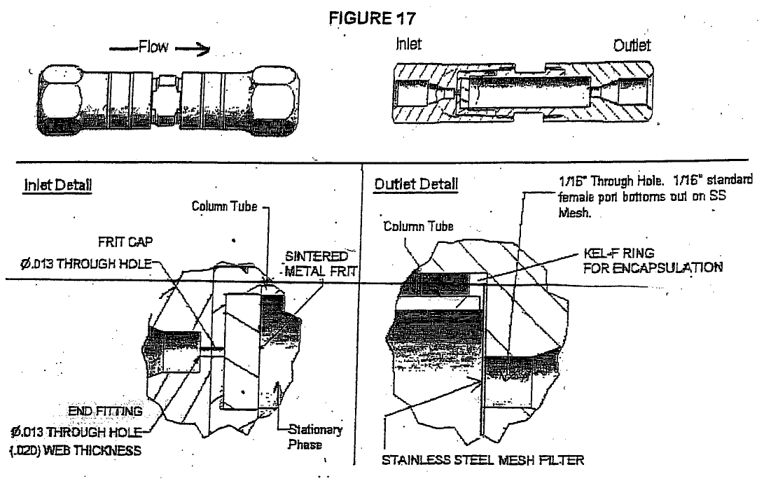

FIG. 18 displays inlet and outlet details.

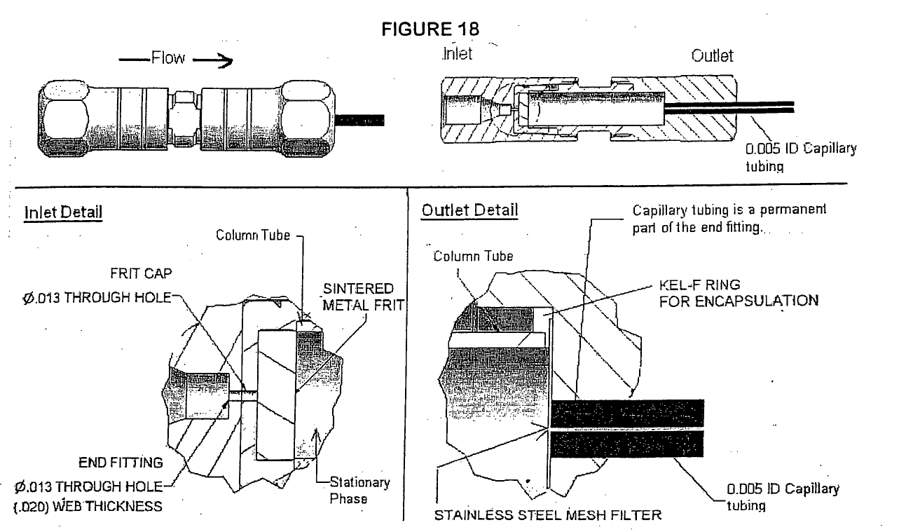

FIG. 19 displays inlet and outlet details.

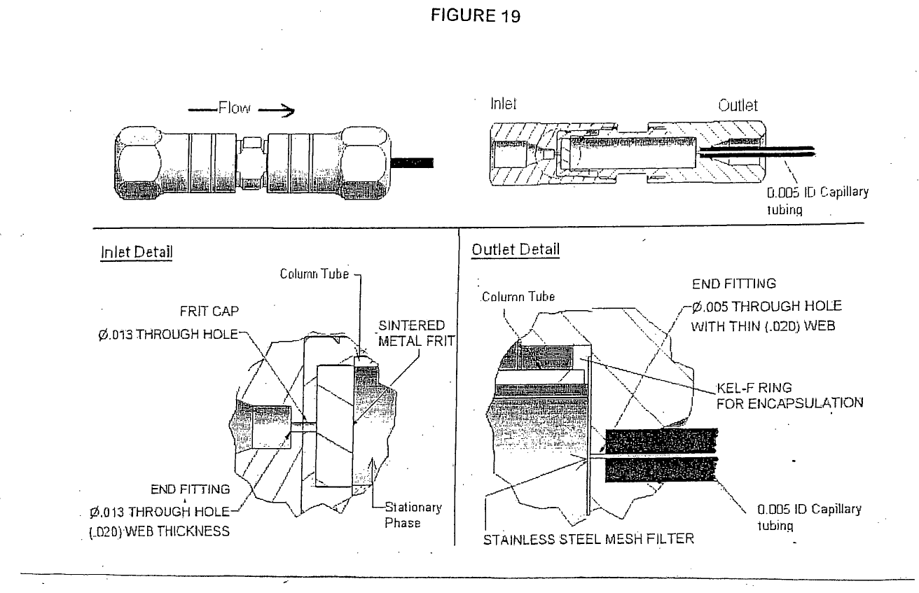

FIG. 20 displays the 2.1 mm concept

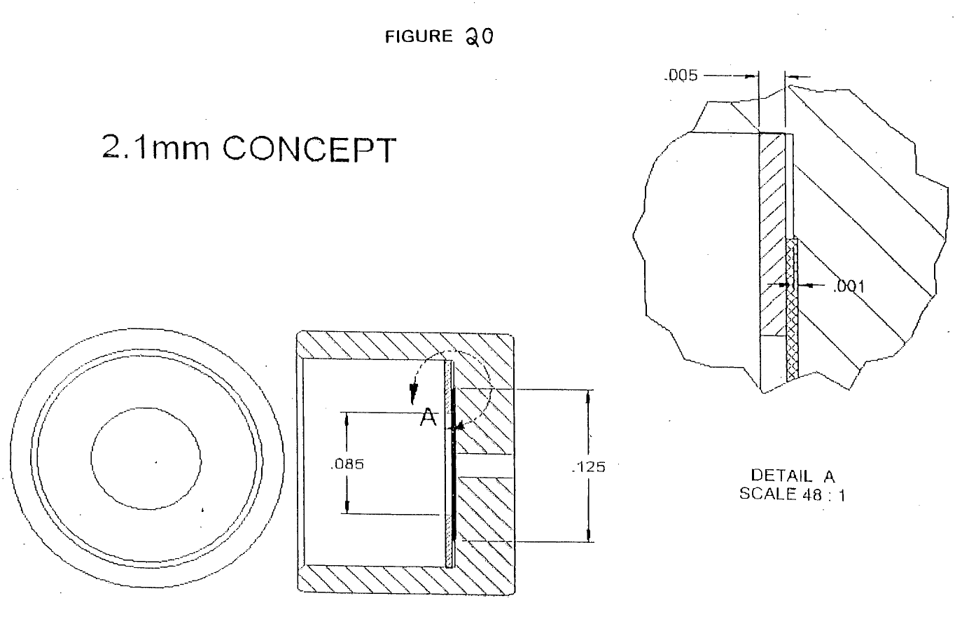

### DETAILED DESCRIPTION OF THE INVENTION

The present invention comprises the next generation of narrow bore HPLC Column Hardware. While considerable attention has been paid to capillary column hardware, little has changed since the introduction of microbore columns in the early 1980's. 1.0 and 2.1 mm ID columns are essentially smaller versions of their 4.6 mm predecessors with many of the same components. The promise of narrow bore columns has largely been fulfilled yet there is still room for improvement when one considers the impact of dead volume on peak shape and plate count. The effects of dead volume on band broadening and the resulting chromatography have been well studied and documented for many years. The effects of dead volume are critical when using narrow bore columns as the impact on band broadening greatly increases compared to analytical columns. To optimize the use of narrow bore columns it is essential to reduce the potential dead volume throughout the flow path in the system and the HPLC column.

While dead volume can occur throughout the HPLC column and instrument, the focus of the present invention is on the HPLC column end fittings and frits. It is essential that dead volume be minimized in narrow bore columns yet most utilize the same frits and fittings as analytical columns (4.6 mm ID). With this in mind the inventors have developed and designed narrow bore column hardware that provides the ultimate configuration to obtain optimum peak shape, improved sensitivity and reduced backpressure.

Results

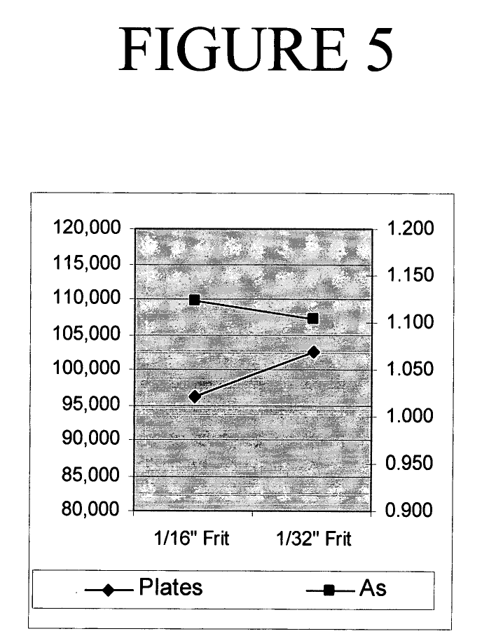

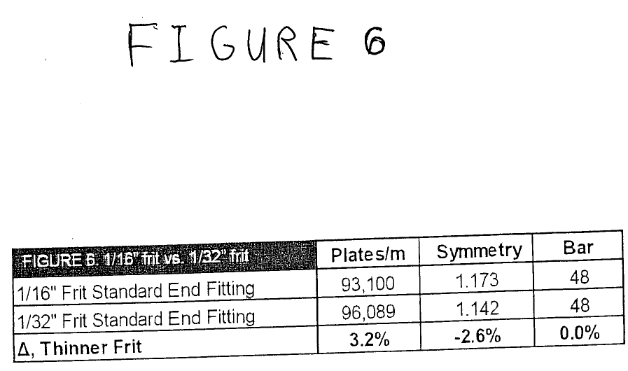

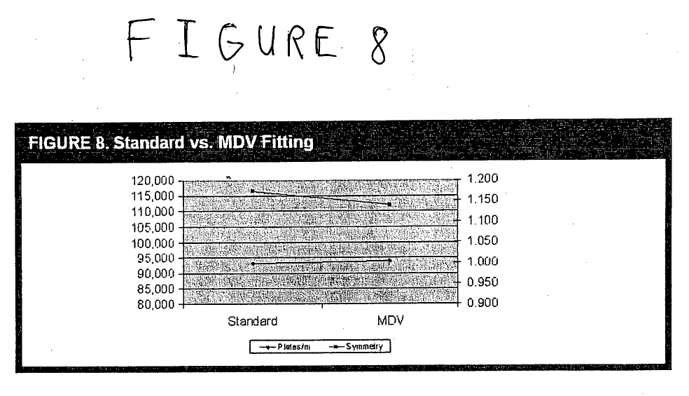

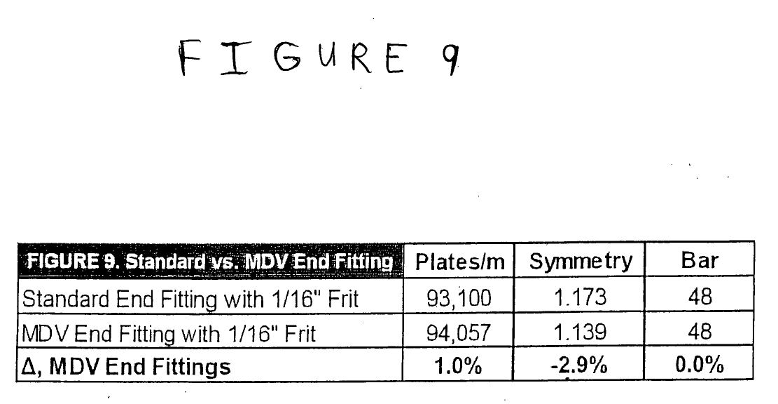

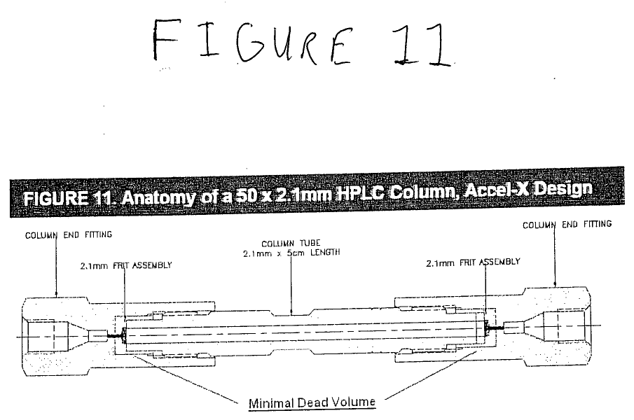

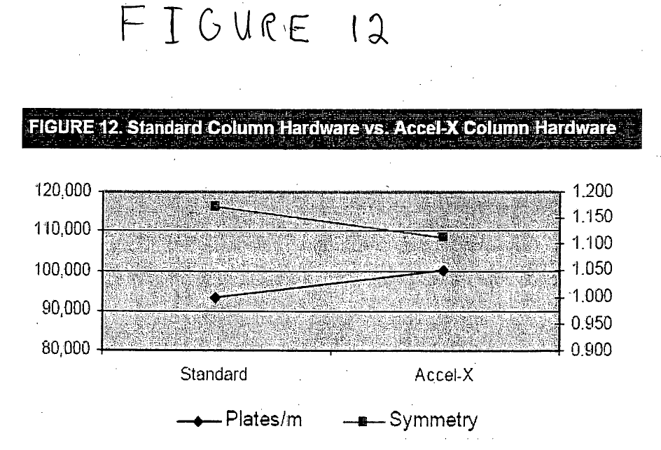

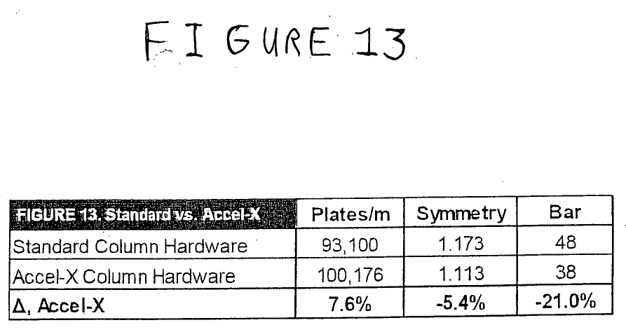

Accel-X™ narrow bore column hardware has been engineered to minimize dead volume. By reducing the frit thickness, as seen in FIGS. 5 and 6, we achieved improvements in peak shape and plate count. Further reduction in dead volume was gained by re-configuring the end fitting (FIGS. 8 and 9) and as a result there was improvement in peak shape and plate count. By improving the quality of the frit combined with the reconfigured end fitting a dramatic improvement was achieved. As shown in FIGS. 11-13, plate count and peak shape improved with a significant reduction in backpressure.

Experimental Conditions

The data to support the present invention was produced by packing 50×2.1 mm columns with Kromasil 3.5μC18. Each experiment was repeated five times to ensure reproducibility. The reported plate count, symmetry and backpressure were an average of the five experiments. Plate count and symmetry data was reported for the last eluting peak: Naphthalene.

Isocratic Conditions

Mobile Phase—60:40 acetonitrile:water

Flow Rate—0.2 ml/min

VWD—254 nm

Sample—Uracil, acetophenone, methyl benzoate, toluene, naphthalene

Injection Volume—2 μl

Instrument—Agilent 1100 binary gradient, Chemstation software

Injector—Rheodyne 8125

Flow Cell—semi-micro

System Tubing—0.005″ID×15 cm injector to column, 0.005″ID×10 cm column to detector.

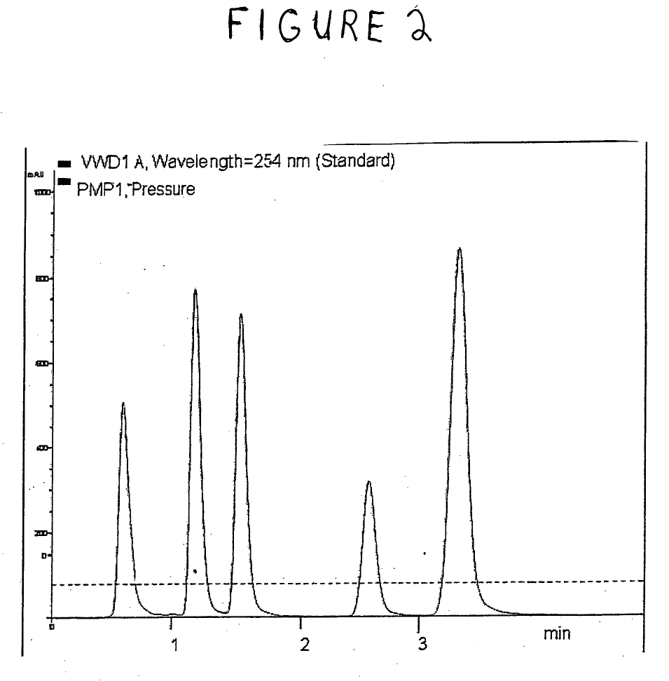

To establish a baseline, five columns were packed and tested. The data from FIG. 2 demonstrates that these are acceptable columns for use under isocratic and ballistic gradient conditions.

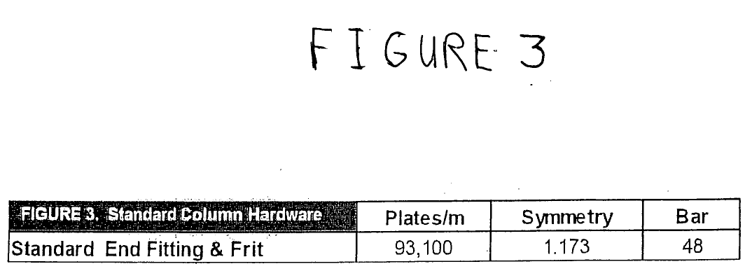

Suspecting that dead volume was present in the frit, reducing the frit thickness should have an impact. The 1/16″thick frits were replaced with 1/32″thick frits. While the data obtained on the initial columns were acceptable (FIGS. 2 and 3), the data on the same columns with thinner frits exhibited improved plate count and symmetry as shown in FIGS. 5 and 6.

As can be seen from FIG. 6, the impact of reduced frit thickness is clearly demonstrated in the increase in plate count and improved peak shape.

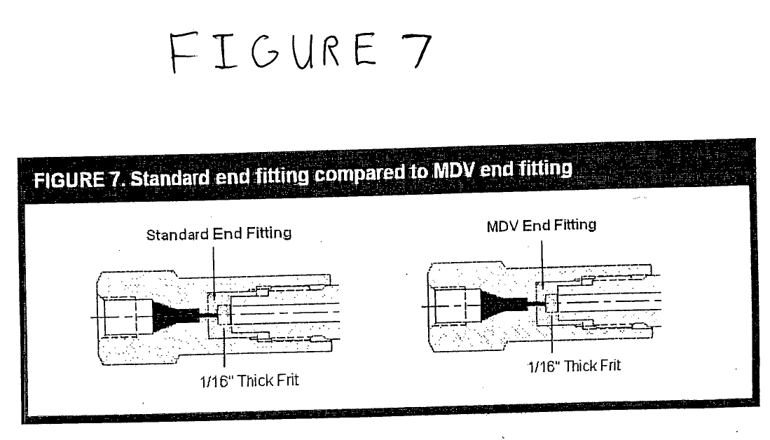

Potential dead volume was previously identified in the end fittings. Once again, the original columns with 1/16″ frits were used for this set of experiments (FIGS. 2 & 3). The end fittings were replaced with a new version with minimal dead volume (MDV). As demonstrated in FIGS. 7 & 8, the end fittings with reduced dead volume had a positive impact in the form of increased plate count and reduced band broadening.

A Pleasant Surprise—Reduced Back Pressure

The results in the previous experiments provide sound evidence that by reducing the dead volume in the end fitting and frit, improvement in the performance of the HPLC column is achieved. The next step in our research culminated in a holistic approach to HPLC column design. A thorough investigation of flow dynamics in the end fitting and frit were conducted to provide optimum HPLC column performance. The end result, a reduction in backpressure, was quite a surprise.

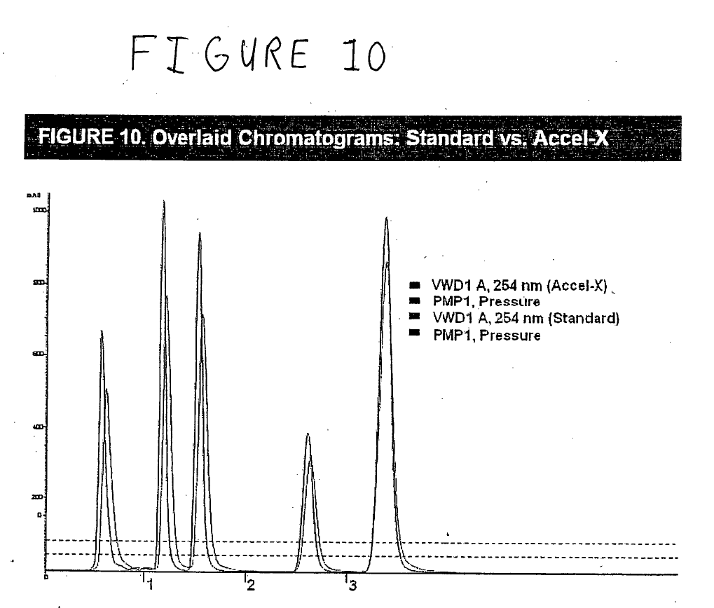

The data from FIGS. 10-13 demonstrates the effectiveness of the Accel-X HPLC column hardware. The combination of a minimal dead volume flow path and an integrated frit provides the ultimate in HPLC column performance.

Once again, the original columns with 1/16″frits were used for this set of experiments (FIGS. 2 and 3). The end fittings were replaced with the Accel-X fittings and integrated frits.

Conclusions

It has been demonstrated how the use of a new HPLC column hardware design can be utilized to improve chromatographic performance as follows:•Reduced backpressure•Reduced band broadening•Increased plate count. These performance enhancements offer many distinct advantages to the analyst. Reduced backpressure allows for use of higher flow rates with longer column lifetimes. Reduced band broadening leads to improvements in peak height, resolution and accuracy of quantitation. This can be especially appealing when sensitivity of the analysis is critical.

We believe that this integrated hardware design is the ultimate configuration for narrow bore HPLC columns possessing all of the strengths and none of the weaknesses of previous generations.

Although the present invention has been described with reference to particular embodiments and with reference to particular sports and uses, it will be apparent to those skilled in the art that variations and modifications can be substituted therefore without departing from the principles and spirit of the invention.

What is claimed is:

1. An HPLC column comprising:
a tube, wherein said tube comprises an inlet and an outlet;
an inlet end fitting;
an outlet end fitting;
an inlet frit, wherein said inlet frit comprises an inlet frit dead volume, an inlet frit material composition, and an inlet frit thickness; and
an outlet frit, wherein said outlet frit comprises an outlet frit dead volume, an outlet frit material composition, and an outlet frit thickness.

2. The HPLC column of claim 1, wherein said outlet frit dead volume is less than said inlet frit dead volume.

3. The HPLC column of claim 1, wherein said outlet frit material composition differs from said inlet frit material composition.

4. The HPLC column of claim 1, wherein said outlet frit thickness differs from said inlet frit thickness.

5. A method for manufacturing an HPLC Column, said method comprising the steps of:
providing an HPLC column to an end user;
incorporating an outlet end fitting during a packing process, wherein said outlet end fitting may be easily removed without disrupting packing material located at an outlet;
replacing said outlet end fitting.

6. The method of claim 5, wherein said step of replacing said outlet end fitting is performed by the end user.
